(19) United States
(12) Patent Application Publication
(10) Pub. No.: US 2024/0322924 A1
(43) Pub. Date: Sep. 26, 2024

(54) TRANSMISSION SPACE REPRODUCTION METHOD AND TRANSMISSION SPACE REPRODUCTION DEVICE

(71) Applicant: NIPPON TELEGRAPH AND TELEPHONE CORPORATION, Tokyo (JP)

(72) Inventors: Ryotaro TANIGUCHI, Musashino-shi, Tokyo (JP); Tomoki MURAKAMI, Musashino-shi, Tokyo (JP); Tomoaki OGAWA, Musashino-shi, Tokyo (JP)

(73) Assignee: NIPPON TELEGRAPH AND TELEPHONE CORPORATION, Tokyo (JP)

(21) Appl. No.: 18/290,829

(22) PCT Filed: Aug. 2, 2021
(86) PCT No.: PCT/JP2021/028657

§ 371 Date: Jan. 22, 2024

(51) Int. Cl. H04B 17/391

(52) U.S. Cl. CPC H04B 17/3912; H04B 17/3913

(57) ABSTRACT

A transmission space reproduction method according to an embodiment includes: a propagation characteristics calculation step of performing simulation while sequentially changing a parameter in a reverberation chamber used to reproduce propagation characteristics so as to calculate propagation characteristics in the reverberation chamber, a machine learning step of forming a learning model for a calculated parameter by machine learning using actually measured propagation characteristics and parameters, a parameter generation step of generating a parameter corresponding to propagation characteristics to be reproduced using the formed learning model, and a reproduction execution step of controlling a channel emulator based on the generated parameter so as to perform processing of forming a transmission space having the propagation characteristics to be reproduced in the reverberation chamber.

### TECHNICAL FIELD

The present invention relates to a transmission space reproduction method and a transmission space reproduction device.

### BACKGROUND ART

Conventionally, when characteristics of a wireless terminal are evaluated, components have been individually evaluated using a wired cable. For example, in the case of evaluating the characteristics of an antenna element, wired coupling of the antenna element has been performed.

However, wireless terminals use radio waves in a millimeter wave band or have higher frequencies, and are downsized and integrated. Moreover, an antenna element or the like may not have a connector adaptable when the antenna element or the like is downsized, and thus the evaluation by wired coupling is difficult. Moreover, even when the test by wired coupling is possible, there is a problem in that the test is complicated and takes time.

Moreover, in a case where Massive MIMO is applied, or the like, it is conceivable to reproduce a propagation environment by arranging a plurality of antennas. However, because the number of antennas to be used is considerably large, there is a problem in that the realization of an ideal configuration requires costs.

In order to solve such a problem, there has been discussed reproduction of a statistical propagation model with a reflector installed in a reverberation chamber as a space for evaluating the characteristics of a wireless terminal.

For example, Non Patent Literature 1 discloses a multiple-probe anechoic chamber method (MPAC) and reverberation chamber methods (RC) as mobile station performance evaluation methods.

In the MPAC, a propagation environment is reproduced by arranging a plurality of antennas. However, the number of antennas to be used is considerably large, and an ideal configuration requires costs. In the RC, a statistical propagation model is reproduced with a reflector such as a stirring plate that is installed in a space (reverberation chamber) where radio waves reverberate.

### CITATION LIST

### Non Patent Literature

Non Patent Literature 1: Ya Jing, Hongwei Kong, Moray Rumney, “MIMO OTA test for a mobile station performance evaluation”, IEEE Instrumentation & Measurement Magazine, Volume: 19, Issue: 3, June 2016, pp. 43-50

### SUMMARY OF INVENTION

### Technical Problem

However, conventionally, there has been a problem in that although it is possible to reproduce a statistical propagation model such as Rayleigh fading by reproducing a multipath environment, it is not possible to reproduce an environment in which radio waves arrive from an arbitrary direction such as a cluster model simulating an environment in which radio cells exist also in the surroundings.

The present invention has been made in view of the above-described problems, and an object of the present invention is to provide a transmission space reproduction method and a transmission space reproduction device capable of easily reproducing a transmission space.

### Solution to Problem

A transmission space reproduction method according to an embodiment of the present invention is characterized in including: a propagation characteristics calculation step of performing simulation while sequentially changing a parameter in a reverberation chamber used to reproduce propagation characteristics so as to calculate propagation characteristics in the reverberation chamber, a machine learning step of forming a learning model for a calculated parameter by machine learning using actually measured propagation characteristics and parameters, a parameter generation step of generating a parameter corresponding to propagation characteristics to be reproduced using the formed learning model, and a reproduction execution step of controlling a channel emulator based on the generated parameter so as to perform processing of forming a transmission space having the propagation characteristics to be reproduced in the reverberation chamber.

Moreover, a transmission space reproduction device according to an embodiment of the present invention is characterized in including: a propagation characteristics calculation unit that performs simulation while sequentially changing a parameter in a reverberation chamber used to reproduce propagation characteristics so as to calculate propagation characteristics in the reverberation chamber, a machine learning unit that forms a learning model for a parameter calculated by the propagation characteristics calculation unit by machine learning using actually measured propagation characteristics and parameters, a parameter generation unit that generates a parameter corresponding to propagation characteristics to be reproduced using the learning model formed by the machine learning unit, and a reproduction execution unit that controls a channel emulator based on the parameter generated by the parameter generation unit so as to perform processing of forming a transmission space having the propagation characteristics to be reproduced in the reverberation chamber.

### Advantageous Effects of Invention

According to the present invention, it is possible to easily reproduce a transmission space.

### BRIEF DESCRIPTION OF DRAWINGS

FIG. 1 is a diagram illustrating a configuration example of a transmission space reproduction device according to an embodiment.

FIG. 2 is a functional block diagram illustrating functions of a control server.

FIG. 3 is a diagram illustrating a method of reproducing a transmission space having predetermined radio wave propagation characteristics to be reproduced in a reverberation chamber and evaluating the characteristics of a measurement object.

FIG. 4 is a diagram illustrating a hardware configuration example of the control server.

### DESCRIPTION OF EMBODIMENTS

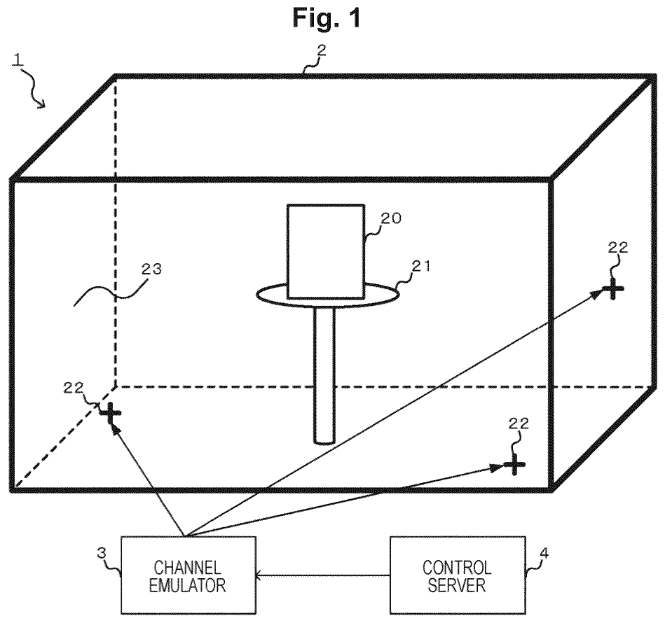

Hereinafter, an embodiment of a transmission space reproduction method and a transmission space reproduction device will be described with reference to the drawings. FIG. 1 is a diagram illustrating a configuration example of a transmission space reproduction device 1 according to an embodiment. As illustrated in FIG. 1, the transmission space reproduction device 1 includes a reverberation chamber 2, a channel emulator 3, and a control server 4.

The reverberation chamber 2 forms a space for reverberating radio waves, and the size and the shape of the reverberation chamber 2 can be changed. For example, the reverberation chamber 2 can be formed in a shape such as a rectangular parallelepiped, a sphere, an n-hedron, an n-prism, or an n-pyramid.

Moreover, in the internal space of the reverberation chamber 2, a measurement object 20 is placed on, for example, a placing table 21. The placing table 21 is configured such that the position and the height of the measurement object 20 in the reverberation chamber 2 can be changed.

Moreover, in the reverberation chamber 2, a plurality of transmission antennas 22 are disposed on, for example, wall surfaces. In the reverberation chamber 2, the number, the positions, and the type of the transmission antennas 22 can be changed.

Moreover, a reflector 23 is disposed on a wall surface of the reverberation chamber 2. The reflector 23 may simply reflect radio waves, or may be a dynamic reflector (intelligent reflecting surface (IRS) or the like) capable of controlling phases of arrival waves when reflecting radio waves, and the type of the reflector 23 can be changed. Moreover, the reflector 23 may have a function as a radio wave absorber that suppresses (or reduces to zero) a reflection amount of radio waves.

The channel emulator 3 transmits radio waves from each of the transmission antennas 22 so as to form a radio wave transmission space accompanied by multipath, interference waves, or the like in the reverberation chamber 2.

The control server 4 is a computer or the like including a processor and a memory, and controls each unit forming the transmission space reproduction device 1.

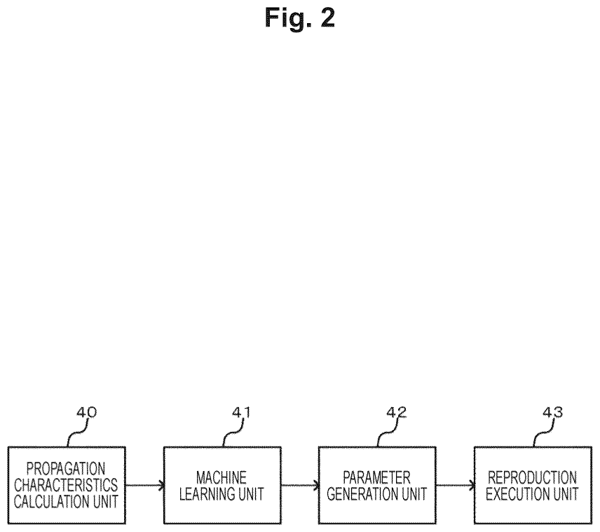

FIG. 2 is a functional block diagram illustrating functions of the control server 4. As illustrated in FIG. 2, the control server 4 includes, for example, a propagation characteristics calculation unit 40, a machine learning unit 41, a parameter generation unit 42, and a reproduction execution unit 43.

The propagation characteristics calculation unit 40 performs simulation using a ray tracing method, a finite-difference time-domain method (FDTD method), or the like while sequentially changing a parameter in the reverberation chamber 2 used to reproduce the propagation characteristics by the transmission space reproduction device 1, for example, so as to calculate the propagation characteristics in the reverberation chamber 2.

The ray tracing method includes a ray launching method and an imaging method. The ray launching method is a method in which rays are discretely radiated at every predetermined angle from a transmission antenna and the trajectories of the rays are sequentially tracked so that a ray having passed through the vicinity of a reception point is regarded as a ray having reached the reception point. The imaging method is a method of determining a reflection transmission path of a ray connecting transmission and reception points by obtaining a mirror point with respect to a reflection surface. The FDTD method is a method of performing electromagnetic field analysis using Maxwell's equations in the time domain.

Then, the propagation characteristics calculation unit 40 outputs propagation characteristics and parameters used to reproduce the propagation characteristics to the machine learning unit 41. For example, the propagation characteristics are indicated by reception power, XPR (polarization ratio of incident field), delay time, arrival direction (horizontal/vertical), delay spread, angular spread, the number of clusters, and the like.

Moreover, parameters in the reverberation chamber 2 used to reproduce the propagation characteristics are, for example, the shape, size, and material of the reverberation chamber 2, the transmission location, transmission signal, and transmission beam direction by the transmission antenna 22, the reception location and reception signal by the measurement object 20, and the like.

Moreover, the propagation characteristics calculation unit 40 may perform simulation while changing parameters of the reflector 23 that is a dynamic reflector provided in the reverberation chamber 2, so as to calculate the propagation characteristics in the reverberation chamber 2.

The machine learning unit 41 forms a learning model for the propagation characteristics and parameters input from the propagation characteristics calculation unit 40 by machine learning using actually measured propagation characteristics and parameters, and outputs the formed learning model to the parameter generation unit 42.

When the propagation characteristics to be reproduced are input, the parameter generation unit 42 generates parameters corresponding to the propagation characteristics to be reproduced using the learning model input from the machine learning unit 41, and outputs the parameters to the reproduction execution unit 43.

The reproduction execution unit 43 controls the channel emulator 3 based on the parameters input from the parameter generation unit 42 so as to perform processing of forming a transmission space having the propagation characteristics to be reproduced in the reverberation chamber 2.

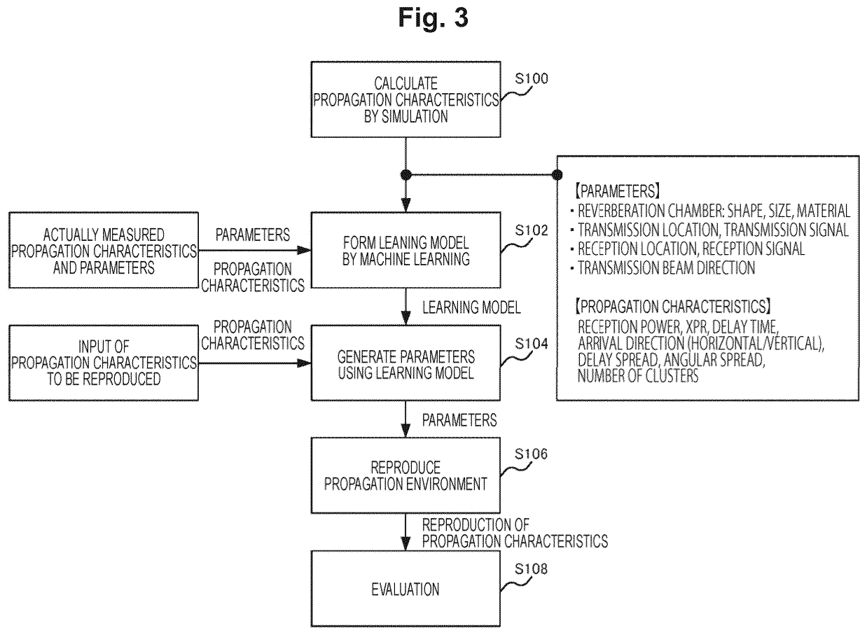

The following will describe a method of reproducing a transmission space having predetermined radio wave propagation characteristics to be reproduced in the reverberation chamber 2 and evaluating the characteristics of the measurement object 20. FIG. 3 is a diagram illustrating a method of reproducing a transmission space having predetermined radio wave propagation characteristics to be reproduced in the reverberation chamber 2 and evaluating the characteristics of the measurement object 20.

As illustrated in FIG. 3, at step 100 (S100), the propagation characteristics calculation unit 40 calculates propagation characteristics by simulation.

At step 102 (S102), the machine learning unit 41 forms a learning model for the propagation characteristics and parameters input from the propagation characteristics calculation unit 40 by machine learning using actually measured propagation characteristics and parameters.

At step 104 (S104), when the propagation characteristics to be reproduced are input, the parameter generation unit 42 generates parameters corresponding to the propagation characteristics to be reproduced using the learning model input from the machine learning unit 41.

At step 106 (S106), the reproduction execution unit 43 controls the channel emulator 3 based on the parameters input from the parameter generation unit 42 so as to perform processing of forming a transmission space having the propagation characteristics to be reproduced (reproducing a pseudo propagation environment) in the reverberation chamber 2.

That is, with the processing performed at S100 to S106, it is possible to reproduce a desired transmission space.

Then, at step 108 (S108), the characteristics of the measurement object 20 are evaluated in the reverberation chamber 2 in which the propagation characteristics are reproduced.

As described above, with the transmission space reproduction device 1, it is possible to reproduce a pseudo propagation environment in the reverberation chamber 2. That is, the transmission space reproduction device 1 can easily reproduce a transmission space.

For example, the transmission space reproduction device 1 can reproduce a real environment in the reverberation chamber 2 by performing machine learning on propagation characteristics in a real environment such as arrival directions of radio waves and determining an installation place of the reflector 23 and the like in the reverberation chamber 2.

Note that some or all of the functions of each of the channel emulator 3 and the control server 4 may be configured by hardware such as a programmable logic device (PLD) or a field programmable gate array (FPGA), or may be configured as a program executed by a processor such as a CPU.

For example, the channel emulator 3 and the control server 4 can be implemented by using a computer and a program, and the program can be recorded on a storage medium or provided via a network.

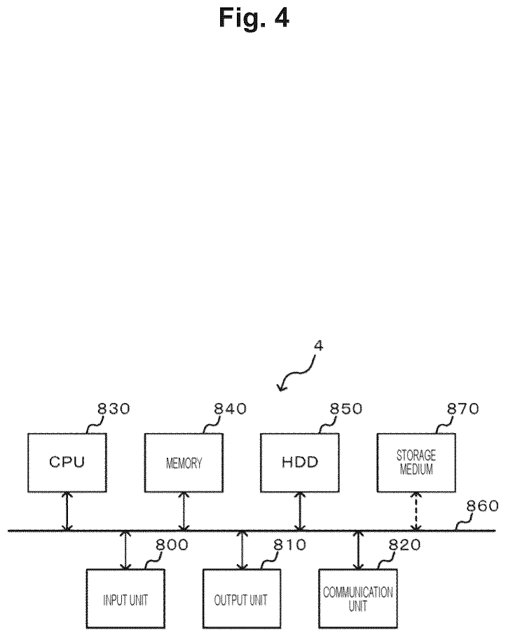

FIG. 4 is a diagram illustrating a hardware configuration example of the control server 4. As illustrated in FIG. 4, for example, the control server 4 has a function as a computer in which an input unit 800, an output unit 810, a communication unit 820, a central processing unit (CPU) 830, a memory 840, and a hard disk drive (HDD) 850 are connected via a bus 860. Moreover, the control server 4 can input and output data to and from a computer-readable storage medium 870.

The input unit 800 is, for example, a keyboard, a mouse, or the like. The output unit 810 is, for example, a display device such as a display. The communication unit 820 is, for example, a network interface or the like.

The CPU 830 controls each unit forming the control server 4, and performs predetermined processing and the like. The memory 840 and the HDD 850 are storage units that store data and the like.

The storage medium 870 can store programs and the like for executing the functions of the control server 4. Note that the architecture of the control server 4 is not limited to the example illustrated in FIG. 4.

### REFERENCE SIGNS LIST

1 transmission space reproduction device
2 reverberation chamber
3 channel emulator
4 control server
20 measurement object
21 placing table
22 transmission antenna
23 reflector
40 propagation characteristics calculation unit
41 machine learning unit
42 parameter generation unit
43 reproduction execution unit
800 input unit
810 output unit
800 communication unit
830 CPU
840 memory
850 HDD
860 bus
870 storage medium

1. A transmission space reproduction method comprising:
simulating while sequentially changing a parameter in a reverberation chamber used to reproduce propagation characteristics so as to calculate propagation characteristics in the reverberation chamber:
forming a learning model for a calculated parameter by machine learning using actually measured propagation characteristics and parameters:
generating a parameter corresponding to propagation characteristics to be reproduced using the formed learning model; and
controlling a channel emulator based on the generated parameter so as to perform processing of forming a transmission space having the propagation characteristics to be reproduced in the reverberation chamber.

2. The transmission space reproduction method according to claim 1, wherein in simulating, the simulation is performed while further changing a parameter of a dynamic reflector that is provided in the reverberation chamber and is capable of controlling phases of arrival waves when reflecting radio waves so as to calculate the propagation characteristics in the reverberation chamber.

3. A transmission space reproduction device comprising:
a propagation characteristics calculation circuitry configured to perform simulation while sequentially changing a parameter in a reverberation chamber used to reproduce propagation characteristics so as to calculate propagation characteristics in the reverberation chamber:
a machine learning circuitry configured to form a learning model for a parameter calculated by the propagation characteristics calculation circuitry by machine learning using actually measured propagation characteristics and parameters:
a parameter generation circuitry configured to generate a parameter corresponding to propagation characteristics to be reproduced using the learning model formed by the machine learning circuitry; and
a reproduction execution circuitry configured to control a channel emulator based on the parameter generated by the parameter generation circuitry so as to perform processing of forming a transmission space having the propagation characteristics to be reproduced in the reverberation chamber.

4. The transmission space reproduction device according to claim 3, wherein the propagation characteristics calculation circuitry performs the simulation while further changing a parameter of a dynamic reflector that is provided in the reverberation chamber and is capable of controlling phases of arrival waves when reflecting radio waves so as to calculate the propagation characteristics in the reverberation chamber.
